(19) United States
(12) Patent Application Publication
(10) Pub. No.: US 2022/0066500 A1
(43) Pub. Date: Mar. 3, 2022

(54) APPARATUS HAVING INFLATION BLADDERS

(71) Applicant: Hewlett-Packard Development Company, L.P., Spring, CA (US)

(72) Inventors: Mithra Vankipuram, Palo Alto, CA (US); Ian N. Robinson, Palo Alto, CA (US); Robert Paul Martin, Fort Collins, CO (US)

(73) Assignee: Hewlett-Packard Development Company, L.P., Spring, TX (US)

(21) Appl. No.: 17/415,896

(22) PCT Filed: Apr. 5, 2019
(86) PCT No.: PCT/US2019/025981

§ 371 Date: Jun. 18, 2021

(51) Int. Cl. G06F 1/16; G06F 3/01

(52) U.S. Cl. CPC G06F 1/163; G06F 3/015

(57) ABSTRACT

In some examples, an apparatus can include a head strap having an inner surface, an inflatable bladder located around the inner surface of the head strap, and a sensor located on the inflatable bladder, where inflation of the inflatable bladder causes the sensor to be in contact with an outer surface of a user of the head strap.

### BACKGROUND

Head mounted mixed reality (MR) devices may be used to provide an altered reality to a user. An MR device may include a virtual reality (VR) device and/or an augmented reality (AR) device. MR devices may include displays to provide a “virtual and/or augmented” reality experience to the user by providing video, images, and/or other visual stimuli to the user via the displays. MR devices may include audio output devices to provide audible stimuli to the user to further the virtual reality experienced by the user. MR devices may be worn by a user.

### BRIEF DESCRIPTION OF THE DRAWINGS

FIG. 1 is a perspective view of an example of an apparatus having an inflatable bladder consistent with the disclosure.

FIG. 2 is a perspective view of an example of an apparatus having inflatable bladders consistent with the disclosure.

FIG. 3 is a perspective view of an example mixed reality (MR) headset having inflatable bladders and a controller consistent with the disclosure.

FIG. 4 is a top view of an example MR headset having inflatable bladders consistent with the disclosure.

FIG. 5 is a top view of an example MR headset having a first set of inflatable bladders and a second set of inflatable bladders consistent with the disclosure.

FIG. 6 is a perspective view of an example MR headset having an inflatable gasket around a surface of a MR display enclosure consistent with the disclosure.

### DETAILED DESCRIPTION

MR devices may provide an altered reality to a user by providing video, audio, images, and/or other stimuli to a user via a display. As used herein, the term “MR device” refers to a device that provides a virtual and/or augmented reality experience for a user.

The MR device may be experienced by a user through the use of a head mount device (e.g., a headset). For example, a user may wear the headset in order to view the display of the MR device and/or experience audio stimuli of the MR device. As used herein, the term “mixed reality” refers to a computing device generated scenario that simulates experience through senses and perception. In some examples, a MR device may cover a user's eyes and provide visual stimuli to the user via a display, thereby substituting a “mixed” reality (e.g., a “virtual reality” and/or “augmented reality”) for actual reality. In some examples, a MR device may cover a user's ears and provide audible stimuli to the user via audio output devices to enhance the virtual reality experienced by the user. In some examples, a MR device may provide an overlay transparent or semi-transparent screen in front of a user's eyes such that reality is “augmented” with additional information such as graphical representations and/or supplemental data. For example, a MR device may overlay transparent or semi-transparent weather information, directions, and/or other information on a MR display for a user to examine.

A headset can be a useful way to orient the MR device in front of a user such that the user can experience the “mixed” reality. As used herein, the term “headset” refers to a device having a headband to hold an electronic device near a user's face such that the user can interact with the electronic device. However, headsets may fit differently on different users' heads. For example, many potential users of the headset can have differently sized and/or shaped heads. As a result, a “one size fits all” headset may provide for an uncomfortable user experience, since the headset may be too big, too small, wrongly shaped for certain heads, etc.

Additionally, as a result of MR devices covering a user's eyes and/or ears, the user may be immersed in the virtual reality created by a MR device. The immersive MR experience can allow the user to experience a virtual reality with realistic images, sounds, and/or other sensations. An immersive MR experience may be enhanced utilizing biological information from the user as the user is immersed in the MR experience.

An apparatus having inflation bladders, according to the disclosure, can allow for a headset to be utilized in a MR experience while using inflatable bladders to provide for a headset that comfortably fits on users' heads. The inflatable bladders can conform to different head shapes to provide a comfortable fit such that a user can continue to comfortably wear the headset for a longer term than a “one size fits all” headset. Additionally, the inflatable bladders can provide for optimal skin contact between a user and sensors included on the headset to reliably collect biometric information about the wearer of the headset.

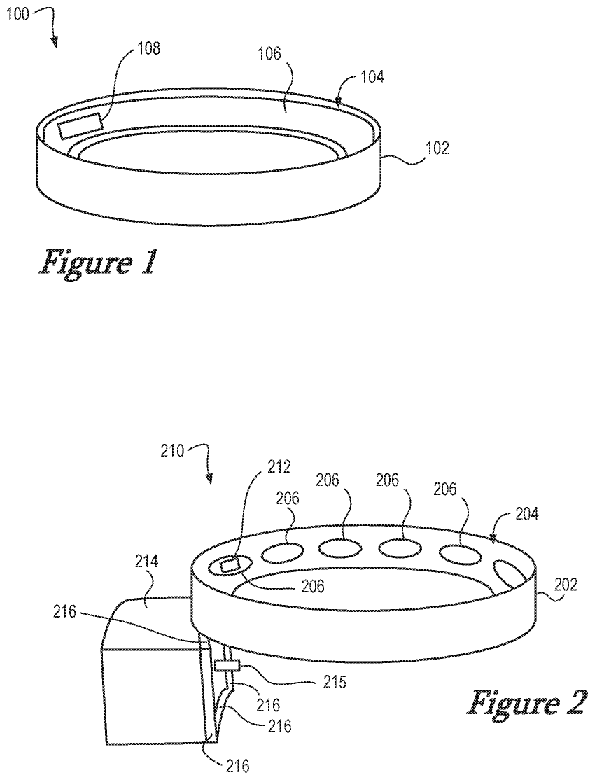

FIG. 1 is a perspective view of an example of an apparatus 100 having an inflatable bladder 106 consistent with the disclosure. Apparatus 100 can include a head strap 102. The head strap 102 can include an inner surface 104 and an inflatable bladder 106. The inflatable bladder 106 can include a sensor 108.

As illustrated in FIG. 1, apparatus 100 can include a head strap 102. As used herein, the term “head strap” refers to a strip of material to fasten and/or hold things together. For example, head strap 102 can be a looped band which fastens to a user's head such that the head strap 102 is secured to the user's head. In some examples, head strap 102 can be an elastic material such as an elastomer or an elastic cloth material, among other examples.

Head strap 102 can include inner surface 104. Inner surface 104 can be a surface that is located proximate to a user's head. For example, when a user wears apparatus 100, the head strap 102 can surround the user's head and the inner surface 104 can be located adjacent to the user's head.

Apparatus 100 can include an inflatable bladder 106. As used herein, the term “bladder” refers to an inflatable container. For example, inflatable bladder 106 can be inflated with fluid such that the inflatable bladder 106 includes fluid within inflatable bladder 106. A fluid can include, for example, a gas, liquid (e.g., water or other liquids), etc.

In some examples, inflatable bladder 106 can be filled with air. However, examples of the disclosure are not so limited. For example, inflatable bladder 106 can be inflated with any other gas.

Inflatable bladder 106 can be located around the inner surface 104 of head strap 102. For example, inflatable bladder 106 can be located such that when a user wears apparatus 100, the head strap 102 can surround the user's head and the inflatable bladder 106 can be located adjacent to the user's head.

Inflatable bladder 106 can provide a cushion against which a user's head can rest when the user is wearing apparatus 100. For example, inflatable bladder 106 can cushion the user's head from head strap 102. The inflatable bladder 106 can conform to the shape of a user's head. Providing a conformable cushion for a user's head via inflatable bladder 106 can allow a user to wear the apparatus 100 for a period of time without discomfort to the user.

Although head strap 102 is illustrated in FIG. 1 as including one inflatable bladder 106 located around the inner surface 104 of head strap 102, examples of the disclosure are not so limited. For example, head strap 102 can include a plurality of inflatable bladders. For instance, inflatable bladder 106 can be one of a set of inflatable bladders, as is further described in connection with FIGS. 2-5.

Inflatable bladder 106 can be inflated via an inflation mechanism. As used herein, the term “inflation mechanism” refers to a device which causes a bladder to expand and/or distend with gas. For example, the inflation mechanism can inflate inflatable bladder 106 by forcing gas into inflatable bladder 106. The inflation mechanism can include a bellows, mechanical lever, electric motor powering a pump, among other types of inflation mechanisms, as is further described in connection with FIG. 5.

Apparatus 100 can include a sensor 108. Sensor 108 can be located on inflatable bladder 106. As used herein, the term “sensor” refers to a device to detect events and/or changes in its environment and transmit the detected events and/or changes for processing and/or analysis.

Sensor 108 can be a biometric sensor located on inflatable bladder 106. As used herein, the term “biometric sensor” refers to a device to detect events and/or changes related to a person based on a physiological and/or behavioral characteristic. For example, the biometric sensor can detect events/changes related to the user wearing apparatus 100.

Inflation of inflatable bladder 106 can cause sensor 108 to be in contact with an outer surface of a user of the head strap 102. For example, as previously described above, the inflatable bladder 106 can conform to the shape of a user's head. As inflatable bladder 106 conforms to the shape of a user's head, sensor 108 can be caused to be in contact with the surface of the user. For example, the sensor 108 can come into contact with the user's skin as a result of inflatable bladder 106 being in an inflated state. As used herein, the term “inflated state” refers to a state in which a container (e.g., an inflatable bladder) includes gas provided by an inflation mechanism.

As described above, sensor 108 can be a biometric sensor. In some examples, sensor 108 can be a heart rate sensor. As used herein, the term “heart rate sensor” refers to a sensor which measures a user's heart rate. For example, sensor 108 can be a heart rate sensor to measure a heart rate of the user of apparatus 100. Heart rate, as a signal, can be used to determine a user's emotional response to virtual reality content. Additionally, it can also be used to determine states of relaxation in the user or mental workload a user may be experiencing while in virtual reality, among other examples.

In some examples, sensor 108 can be a galvanic skin response sensor. As used herein, the term “galvanic skin response sensor” refers to a sensor which measures variations in electrical characteristics (e.g., electrodermal activity) of a user's skin. For instance, the galvanic skin response sensor can measure a user's skin for conductance. The galvanic skin response sensor can determine an intensity of a user's emotional state. Galvanic skin response, as a signal, can be used to determine states of relaxation in the user or mental workload a user may be experiencing while in virtual reality, among other examples.

In some examples, sensor 108 can be an electroencephalography (EEG) sensor. As used herein, the term “EEG sensor” refers to a sensor which measures electrical activity of a user's brain. For instance, the EEG sensor can measure voltage fluctuations resulting from ionic current within the neurons of a user's brain. EEG signals may be used to determine a user's emotional response to virtual reality content. Additionally, EEG signals can also be used to determine states of relaxation in the user or mental workload a user may be experiencing while in virtual reality, among other examples.

In some examples, sensor 108 can be an electromyography (EMG) sensor. As used herein, the term “EMG sensor” refers to a sensor which measures electrical activity produced by skeletal muscles of a user. For instance, the EMG sensor can measure electrical potential generated by muscle cells of a user when such cells are electrically or neurologically activated. EMG signals may be used to determine a user's emotional response to virtual reality content, among other examples.

Although sensor 108 is described above as being a heart rate sensor, a galvanic skin response sensor, an EEG sensor, and/or an EMG sensor, examples of the disclosure are not so limited. For example, sensor 108 can be any other type of sensor (e.g., biometric or otherwise).

Although not illustrated in FIG. 1, apparatus 100 can further include a mixed reality (MR) display enclosure, as is further described in connection with FIGS. 2-5. The head strap 102 can be connected to the MR display enclosure. The MR display enclosure can be utilized to provide an immersive MR experience to a user of apparatus 100.

FIG. 2 is a perspective view of an example of an apparatus 210 having inflatable bladders 206 consistent with the disclosure. Apparatus 210 can include a head strap 202 and MR display enclosure 214. Head strap 202 can include an inner surface 204 and inflatable bladders 206. Particular inflatable bladders of the inflatable bladders 206 can include a biometric sensor 212. MR display enclosure 214 can include inflatable gasket 216. Inflatable gasket 216 can include biometric sensor 215.

As previously described in connection with FIG. 1, apparatus 210 can include a head strap 202 having an inner surface 204. The inner surface 204 can include a plurality of inflatable bladders 206 around inner surface 204 of the head strap 202.

Inflatable bladders 206 can be filled with a gas (e.g., air or other types of gases). The set of inflatable bladders 206 can be oriented in a spaced apart manner around inner surface 204 of head strap 202. The set of inflatable bladders 206 can provide a cushion against which a user's head can rest when the user is wearing apparatus 210. The set of inflatable bladders 206 can conform to the shape of a user's head to provide a conformable cushion for a user's head to allow a user to wear the apparatus 210 for a period of time without discomfort to the user.

As illustrated in FIG. 2, one of the inflatable bladders 206 can include biometric sensor 212. As previously described in connection with FIG. 1, biometric sensor 212 can be located on an inflatable bladder 206 such that as a result of inflatable bladder 206 being inflated, biometric sensor 212 can be in contact with an outer surface (e.g., skin) of a user of apparatus 210. Biometric sensor 212 can be a heart rate sensor, galvanic skin response sensor, EEG sensor, and/or EMG sensor, among other types of biometric sensors.

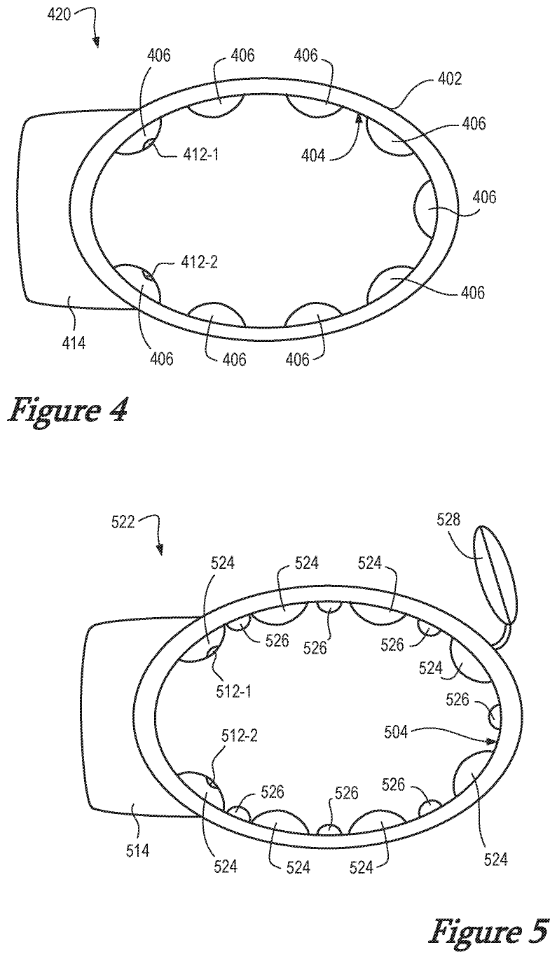

Although apparatus 210 is illustrated in FIG. 2 as including one biometric sensor 212, examples of the disclosure are not so limited. For example, apparatus 210 can include more than one biometric sensor 212 which can be located on different inflatable bladders 206, as is further described in connection with FIGS. 4 and 5.

Further, although biometric sensor 212 is located on an inflatable bladder 206 proximate to the MR display enclosure 214, examples of the disclosure are not so limited. For example, biometric sensor 212 can be located on any other inflatable bladder 206.

Apparatus 210 can include MR display enclosure 214. As used herein, the term “MR display enclosure” refers to a device which can house various devices to provide a MR experience to a user. For example, MR display enclosure 214 can include devices to provide visual, audible, and/or other stimuli to provide a “virtual” reality to a user of apparatus 210. Devices may include displays, speakers, haptic feedback devices, among other types of devices.

MR display enclosure 214 can include an inflatable gasket 216. As used herein, the term “inflatable gasket” refers to an inflatable container which can prevent or restrict light from passing between skin of a user and the MR display enclosure. For example, inflatable gasket 216 can rest against skin of a user of apparatus 210 when a user wears apparatus 210 to prevent outside light from disturbing the “virtual” experience. The inflatable gasket 216 can be located around a surface of the MR display enclosure 214 and can provide a conformable cushion for a user's face while the user wears apparatus 210, which can allow the user to wear the apparatus 210 for a period of time without discomfort to the user.

Inflatable gasket 216 can include biometric sensor 215. In some examples, biometric sensor 215 can be an EMG sensor as an EMG sensor can receive an adequate biometric signal when located/placed for sensing in a facial area of a user. However, examples of the disclosure are not so limited. For example, biometric sensor 215 can be a heart rate sensor, a galvanic skin response sensor, an EEG sensor, and/or an EMG sensor, among other types of biometric sensors.

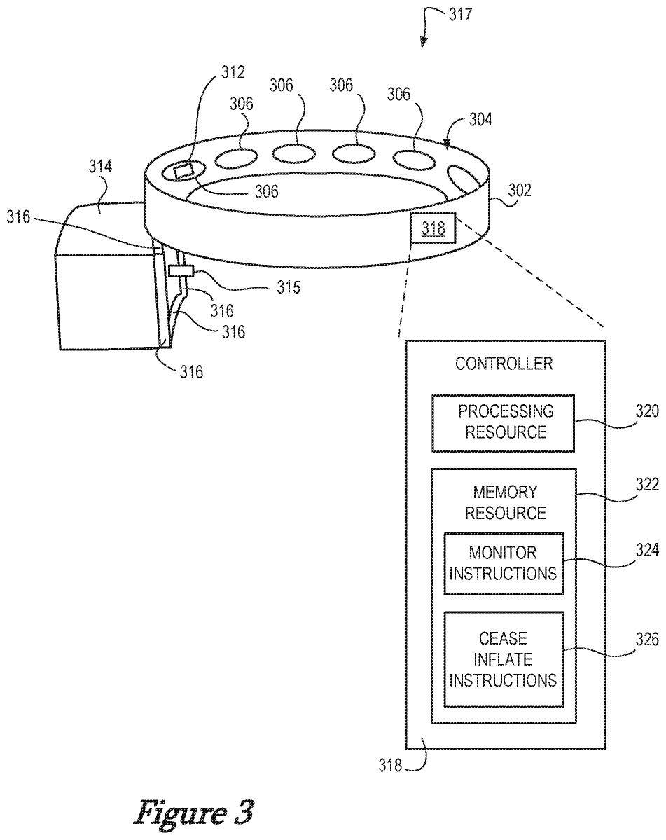

FIG. 3 is a perspective view of an example mixed reality (MR) headset 317 having inflatable bladders 306 and a controller 318 consistent with the disclosure. MR headset 317 can include a head strap 302. MR display enclosure 314, and controller 318. Head strap 302 can include an inner surface 304 and inflatable bladders 306. Particular inflatable bladders of the inflatable bladders 306 can include a biometric sensor 312. MR display enclosure 314 can include inflatable gasket 316. Controller 318 can include processing resource 320 and memory resource 322.

As previously described in connection with FIGS. 1 and 2, MR headset 317 can include a head strap 302 having an inner surface 304. The inner surface 304 can include a plurality of inflatable bladders 306 around inner surface 304 of the head strap 302.

The set of inflatable bladders 306 can provide a cushion against which a user's head can rest when the user is wearing MR headset 317. The set of inflatable bladders 306 can conform to the shape of a user's head to provide a conformable cushion for a user's head to allow a user to wear the MR headset 317 for a period of time without discomfort to the user

Additionally, MR headset 317 can include inflatable gasket 316. Inflatable gasket 316 can rest against skin of a user of MR headset 317 when a user wears MR headset 317 to prevent outside light from disturbing the “virtual and/or augmented reality” experience. The inflatable gasket 316 can be located around a surface of the MR display enclosure 314 and can provide a conformable cushion for a user's face while the user wears MR headset 317, which can allow the user to wear the MR headset 317 for a period of time without discomfort to the user.

As illustrated in FIG. 3, one of the inflatable bladders 306 can include biometric sensor 312. As previously described in connection with FIG. 1, biometric sensor 312 can be located on an inflatable bladder 306 such that as a result of inflatable bladder 306 being inflated, biometric sensor 312 can be in contact with an outer surface (e.g., skin) of a user of MR headset 317. Biometric sensor 312 can be a heart rate sensor, galvanic skin response sensor, EEG sensor, and/or EMG sensor, among other types of biometric sensors.

As described herein, controller 318 may perform functions related to an apparatus having inflation bladders. Although not illustrated in FIG. 3, the controller 318 may include a processor and a machine-readable storage medium. Although the following descriptions refer to a single processor and a single machine-readable storage medium, the descriptions may also apply to a system with multiple processors and multiple machine-readable storage mediums. In such examples, the controller 318 may be distributed across multiple machine-readable storage mediums and the controller 318 may be distributed across multiple processors. Put another way, the instructions executed by the controller 318 may be stored across multiple machine-readable storage mediums and executed across multiple processors, such as in a distributed or virtual computing environment.

Processing resource 320 may be a central processing unit (CPU), a semiconductor based microprocessor, and/or other hardware devices suitable for retrieval and execution of machine-readable instructions 324, 326 stored in a memory resource 322. Processing resource 320 may fetch, decode, and execute instructions 324, 326. As an alternative or in addition to retrieving and executing instructions 324, 326, processing resource 320 may include a plurality of electronic circuits that include electronic components for performing the functionality of instructions 324, 326.

Memory resource 322 may be any electronic, magnetic, optical, or other physical storage device that stores executable instructions 324, 326 and/or data. Thus, memory resource 322 may be, for example, Random Access Memory (RAM), an Electrically-Erasable Programmable Read-Only Memory (EEPROM), a storage drive, an optical disc, and the like. Memory resource 322 may be disposed within controller 318, as shown in FIG. 3. Additionally and/or alternatively, memory resource 322 may be a portable, external or remote storage medium, for example, that causes controller 318 to download the instructions 322 from the portable/external/remote storage medium.

The controller 318 may include instructions 324 stored in the memory resource 322 and executable by the processing resource 320 to monitor inflation of the plurality of inflatable bladders 306. For example, during inflation of inflatable bladders 306 (e.g., via an inflation mechanism), a sensor can monitor inflation levels of the inflatable bladders 306 and transmit information about the inflation levels of the inflatable bladders 306 to controller 318. The sensor may be a pressure sensor, among other types of sensors.

The controller 318 may include instructions 326 stored in the memory resource 322 and executable by the processing resource 320 to cause inflation of the plurality of bladders 306 to cease in response to a threshold condition being met. For example, once a threshold condition is met with respect to the inflation of the inflatable bladders 306, controller 318 can cause the inflation of inflatable bladders 306 to cease (e.g., so as to prevent over-inflation and/or damage to the inflatable bladders 306).

In some examples, the threshold condition can be a threshold pressure. For example, controller 318 can monitor pressure levels of inflatable bladders 306 during inflation. In response to a determination that the pressure levels of inflatable bladders 306 meet and/or exceed a threshold pressure, controller 318 can cause inflation of the inflatable bladders 306 to cease.

In some examples, controller 318 can cause excess gas (e.g., air) to be released from the plurality of inflatable bladders 306. For example, in an instance in which an inflation mechanism does not cease inflating inflatable bladders 306, inflatable bladders 306 can include a pressure relief mechanism (e.g., a valve) such that excess gas is released from the plurality of inflatable bladders 306 (e.g., via the pressure relief mechanism) to prevent over-inflation and/or damage to the inflatable bladders 306.

In some examples, the threshold condition can be a threshold biometric sensor signal level such that the controller 318 can cause inflation of the inflatable bladders 306 to cease in response to a threshold biometric signal level being met. For example, in an instance in which a user is wearing MR headset 317 during inflation of inflatable bladders 306, controller 318 can monitor a signal level of biometric sensor 312. For instance, biometric sensor 312 can be a heart rate sensor. Controller 318 can monitor the heart rate signal of a user detected by biometric sensor 312. As inflatable bladders 306 are inflated, the biometric sensor 312 realizes more and more skin contact with the user. As a result, the signal level of the biometric sensor 312 can become better and better and the inflatable bladders 306 are inflated. In response to a threshold signal level being met and/or exceeded (e.g., a sufficient signal to accurately determine a biometric characteristic), controller 318 can cause inflation of inflatable bladders 306 to cease.

In some examples, each inflatable bladder 306 can stop receiving gas during inflation of the inflatable bladders 306 when it reaches a threshold pressure. In some examples, the threshold pressure may be user adjustable. For example, a user may specify certain inflatable bladders 306 to accept more or less gas in order to maximize comfort relative to that user's preferences. For instance, a user may specify inflatable bladders 306 proximate to the MR display enclosure 314 can receive more gas (e.g., to inflate more) than an inflatable bladder 306 opposite to the MR display enclosure 314. In other words, each inflatable bladder 306 can be inflated to a same or differing pressure according to a pre-determined user specified pressure of each inflatable bladder 306.

In some examples, each inflatable bladder 306 can have gas released individually. For example, a user may have a preference of a lower inflatable air bladder pressure for inflatable bladders 306 proximate to the MR display enclosure 314. Accordingly, a user may deflate (e.g., partially or wholly) specific inflatable bladders 306 according to user preferences, but leave the remaining inflatable bladders 306 inflated.

FIG. 4 is a top view of an example MR headset 420 having inflatable bladders 406 consistent with the disclosure. MR headset 420 can include a head strap 402 and MR display enclosure 414. Head strap 402 can include an inner surface 404 and inflatable bladders 406. Particular inflatable bladders of the inflatable bladders 406 can include biometric sensors 412.

As previously described in connection with FIGS. 2 and 3, head strap 402 can include a plurality of inflatable bladders 406. As illustrated in FIG. 4, the inflatable bladders 406 can be spaced apart around inner surface 404 of head strap 402.

The spaced apart inflatable bladders 406 can contact different portions of a user's head. For example, a user that wears MR headset 420 can have inflatable bladders 406 contact and conform to the shape of the user's head such that the MR headset 420 comfortably fits on the user's head. The inflatable bladders 406 can conform to different head shapes to provide a comfortable fit such that a user can continue to comfortably wear the headset for a longer term than a “one size fits all” headset.

Although MR headset 420 is illustrated as including nine inflatable bladders 406, examples of the disclosure are not so limited. For example, MR headset 420 can include more than nine inflatable bladders or less than nine inflatable bladders.

As illustrated in FIG. 4, inflatable bladders 406 can include biometric sensors 412-1 and 412-2. In some examples, biometric sensors 412-1 and 412-2 can be the same type of biometric sensor (e.g., both biometric sensors 412-1 and 412-2 being EEG sensors, etc.). In some examples, biometric sensor 412-1 can be a first type of biometric sensor (e.g., a galvanic skin response sensor) and biometric sensor 412-2 can be a second type of biometric sensor (e.g., an EEG sensor). In other words, biometric sensors 412-1 and 412-2 can be different types of biometric sensors.

Additionally, although biometric sensors 412-1 and 412-2 are illustrated as being located on inflatable bladders 406 located proximate to MR display enclosure 414, examples of the disclosure are not so limited. For example, biometric sensors 412-1 and 412-2 can be located on any other of the inflatable bladders 406.

FIG. 5 is a top view of an example MR headset 522 having a first set of inflatable bladders 524 and a second set of inflatable bladders 526 consistent with the disclosure. MR headset 522 can include a head strap 502 and MR display enclosure 514. Head strap 502 can include a first set of inflatable bladders 524 and a second set of inflatable bladders 526. Particular inflatable bladders 524, 526 can include biometric sensors 512.

As previously described in connection with FIGS. 2-4, head strap 502 can include a plurality of inflatable bladders 524, 526. As illustrated in FIG. 5, the inflatable bladders 524, 526 can be spaced apart around an inner surface of head strap 502.

As illustrated in FIG. 5, MR headset 522 can include a first set of inflatable bladders 524 and a second set of inflatable bladders 526. The first set of bladders 524 can be in an inflated state and the second set of bladders 526 can be in a deflated state. As used herein, the term “deflated state” refers to a state in which a container (e,g., an inflatable bladder) does not include gas provided by an inflation mechanism (e.g., inflation mechanism 528).

The first set of inflatable bladders 524 can contact different portions of a user's head. For example, a user that wears MR headset 522 can have a first set of inflatable bladders 524 that are in an inflated state, in contact with, and conformed to the shape of the user's head such that the MR headset 522 comfortably fits on the user's head.

After a user wears MR headset 522 for a period of time, the areas on a user's head at which the first set of inflatable bladders 524 contact the user's head may become fatigued. Accordingly, the second set of inflatable bladders 526 can be put in an inflated state (e.g., by inflation mechanism 528, in some examples), after which the first set of inflatable bladders 524 can be put into a deflated state. For example, gas included in the first set of inflatable bladders 524 can be released (e.g., through a valve or multiple valves) such that the first set of inflatable bladders 524 are in a deflated state.

As a result, the second set of inflatable bladders 526 can contact different areas of the user's head than the first set of inflatable bladders 526. Since the areas of a user's head at which the second set of inflatable bladders 526 contact the user's head may not be fatigued (e.g., since they have not been in contact with any inflatable bladders 524, 526), a user can comfortably wear MR headset 522 for a longer period of time.

Although the first set of inflatable bladders 524 are described as being inflated when the second set of inflatable bladders 526 are deflated (e.g., as illustrated in FIG. 5), as well as the second set of inflatable bladders 526 being inflated when the first set of inflatable bladders 524 are deflated (e.g., as described above), examples of the disclosure are not so limited. For instance, in some examples, the first set of inflatable bladders 524 and the second set of inflatable bladders 526 can be inflated at the same time (e.g., similar to examples described in connection with FIGS. 1-4).

Although the first set of inflatable bladders 524 are illustrated as including eight inflatable bladders and the second set of inflatable bladders 526 are illustrated as including seven inflatable bladders, examples of the disclosure are not so limited. For example, the first set of inflatable bladders 524 can include more or less than eight inflatable bladders, and the second set of inflatable bladders 526 can include more or less than seven inflatable bladders.

As illustrated in FIG. 5, the first set of inflatable bladders 524 can include biometric sensors 512-1 and 512-2. In some examples, biometric sensors 512-1 and 512-2 can be the same type of biometric sensor (e.g., both biometric sensors 512-1 and 512-2 being EEG sensors, etc.). In some examples, biometric sensor 512-1 can be a first type of biometric sensor (e.g., a galvanic skin response sensor) and biometric sensor 512-2 can be a second type of biometric sensor (e.g., an EEG sensor). In other words, biometric sensors 512-1 and 512-2 can be different types of biometric sensors.

However, examples of the disclosure are not so limited. For example, biometric sensors 512-1 and 512-2 can be located on the second set of inflatable bladders 526. Additionally, in some examples, biometric sensor 512-1 can be located on the first set of inflatable bladders 524, biometric sensor 512-2 can be located on the second set of inflatable bladders 526, and/or vice versa.

Additionally, although biometric sensors 512-1 and 512-2 are illustrated as being located on inflatable bladders 524 located proximate to MR display enclosure 514, examples of the disclosure are not so limited. For example, biometric sensors 512-1 and 512-2 can be located on any other of the inflatable bladders 524, 526.

As illustrated in FIG. 5, MR headset 522 can include inflation mechanism 528. Inflation mechanism 528 can be a bellows (e.g., as illustrated in FIG. 5). As used herein, the term “bellows” refers to a device to produce a current of air having a chamber that can be expanded to raw in air through a valve and contracted to expel the air through a tube. For example, inflation mechanism 528 can be contracted to push air into inflatable bladders 524, 526.

Although inflation mechanism 528 is described above as being a bellows, examples of the disclosure are not so limited. For example, inflation mechanism 528 can include a mechanical lever, an electric motor powering a pump, among other types of inflation mechanisms.

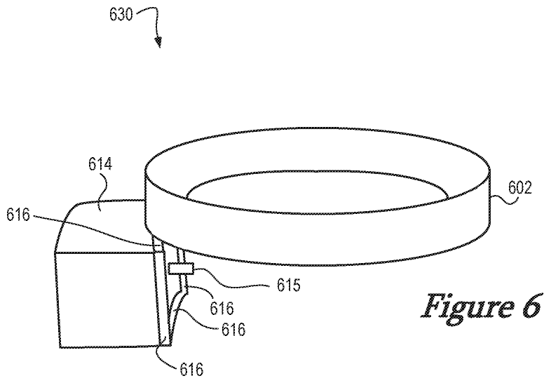

FIG. 6 is a perspective view of an example MR headset 630 having an inflatable gasket 616 around a surface of a MR display enclosure 614 consistent with the disclosure. Apparatus 630 can include a head strap 602 and MR display enclosure 614. MR display enclosure 614 can include inflatable gasket 616. Inflatable gasket 616 can include biometric sensor 615.

MR display enclosure 614 can include an inflatable gasket 616. For example, inflatable gasket 616 can rest against skin of a user of apparatus 630 when a user wears apparatus 630 to prevent outside light from disturbing the “virtual” experience. The inflatable gasket 616 can be located around a surface of the MR display enclosure 614 and can provide a conformable cushion for a user's face while the user wears apparatus 630, which can allow the user to wear the apparatus 630 for a period of time without discomfort to the user.

Inflatable gasket 616 can include biometric sensor 615. Inflation of the inflatable gasket 616 can cause biometric sensor 615 to be in contact with an outer surface of a user of apparatus 630. For example, the inflatable gasket 616 can conform to the shape of a user's face. As inflatable gasket 616 conforms to the shape of a user's face, biometric sensor 615 can be caused to be in contact with the surface of the user. For example, the biometric sensor 615 can come into contact with the user's skin as a result of inflatable gasket 616 being in an inflated state.

In some examples, biometric sensor 615 can be an EMG sensor as an EMG sensor can receive an adequate biometric signal when located/placed for sensing in a facial area of a user. However, examples of the disclosure are not so limited. For example, biometric sensor 615 can be a heart rate sensor, a galvanic skin response sensor, an EEG sensor, and/or an EMG sensor, among other types of biometric sensors.

An apparatus having inflation bladders, according to the disclosure, can allow for a headset to be comfortably utilized by a user while a user experiences a “MR” experience. Inflatable bladders can provide a mechanism by which the headset can comfortably be positioned on a user's head for a period of time longer than can be provided by a “one size fits all” headset. Additionally, the inflatable bladders can provide for optimal skin contact between a user and sensors included on the headset to reliably collect biometric information about the wearer of the headset.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” can refer to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 202 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed is:

1. An apparatus, comprising:
a head strap having an inner surface;
an inflatable bladder located around the inner surface of the head strap; and
a sensor located on the inflatable bladder;
wherein inflation of the inflatable bladder causes the sensor to be in contact with an outer surface of a user of the head strap.

2. The apparatus of claim 1, wherein the inflatable bladder is inflatable via an inflation mechanism.

3. The apparatus of claim 1, wherein the inflatable bladder is one of a set of inflatable bladders.

4. The apparatus of claim 3, wherein the set of inflatable bladders are oriented in a spaced apart manner around the inner surface of the head strap.

5. The apparatus of claim 1, wherein the apparatus further includes a mixed reality (MR) display enclosure.

6. The apparatus of claim 5; wherein the head strap is connected to the MR display enclosure.

7. The apparatus of claim 1, wherein the sensor is a biometric sensor located on the inflatable bladder

8. An apparatus, comprising:
a head strap;
a mixed reality (MR) display enclosure; and
an inflatable gasket located around a surface of the MR display enclosure, wherein the inflatable gasket includes a biometric sensor;
wherein inflation of the inflatable gasket causes the biometric sensor to be in contact with an outer surface of a user of the apparatus.

9. The apparatus of claim 8, wherein:
the head strap includes a plurality of inflatable bladders around an inner surface of the head strap;
at least one bladder of the inflatable bladders includes a biometric sensor; and
inflation of the plurality of inflatable bladders causes the biometric sensor to be in contact with an outer surface of a user of the head strap.

10. The apparatus of claim 9, wherein the plurality of bladders includes a first set of bladders and a second set of bladders, and wherein:
in response to the first set of bladders being inflated, the second set of bladders are deflated; and
in response to the second set of bladders being inflated, the first set of bladders are deflated.

11. The apparatus of claim 10, wherein:
at least one bladder of the first set of bladders includes the biometric sensor; and
at least one bladder of the second set of bladders includes a biometric sensor.

12. A mixed reality (MR) headset, comprising:
a mixed reality (MR) display enclosure, wherein the MR display enclosure includes an inflatable gasket around a surface of the MR display enclosure;
a head strap connected to the MR display enclosure, wherein the head strap includes a plurality of inflatable bladders around an inner surface of the head strap;
a biometric sensor located on an inflatable bladder of the plurality of inflatable bladders; and
a controller including a memory and a processor to execute non-transitory machine-readable instructions stored in the memory to:
monitor inflation of the plurality of inflatable bladders; and
cause inflation of the plurality of inflatable bladders to cease in response to a threshold condition being met.

13. The MR headset of claim 12, wherein the threshold condition is a threshold pressure such that the processor executes the instructions to cause inflation of the plurality of inflatable bladders to cease in response to the threshold pressure being met.

14. The MR headset of claim 13, wherein in response to the threshold pressure being met, the processor executes the instructions to cause excess gas to be released from the plurality of inflatable bladders in response to inflation of the plurality of inflatable bladders continuing.

15. The MR headset of claim 12, wherein the threshold condition is a threshold biometric sensor signal level such that the processor executes the instructions to cause inflation of the plurality of inflatable bladders to cease in response to the threshold biometric sensor signal level being met.
